(19) United States
(12) Patent Application Publication
(10) Pub. No.: US 2024/0375840 A1
(43) Pub. Date: Nov. 14, 2024

(54) PREFORMED LYOPHILIZATION CONTAINERS AND METHODS OF PREPARING THE SAME

(71) Applicant: Terumo BCT, Inc., Lakewood, CO (US)

(72) Inventors: Frank CORBIN, Lakewood, CO (US); Kestas Parakininkas, Englewood, CO (US); James Ladtkow, Btoomfield, CO (US)

(21) Appl. No.: 18/782,165

(22) Filed: Jul. 24, 2024

Related U.S. Application Data
(60) Provisional application No. 63/431,134, filed on Dec. 8, 2022.

(51) Int. Cl. B65D 75/24; B29C 51/10; B29C 51/42; B29K 21/00; B29L 31/00; B65D 65/38; B65D 75/52; F26B 5/06

(52) U.S. Cl. CPC B65D 75/24; B29C 51/10; B29C 51/421; B65D 65/38; B65D 75/52; F26B 5/065; B29K 2021/003; B29K 2995/0065; B29L 2031/712; B65D 2565/388; B65D 2575/3272

(57) ABSTRACT

A lyophilization container includes a first section having a first layer, a second layer aligned with the first layer, and a cavity defined by the alignment of the first and second layers, where at least one of the first and second layers is preformed to have a three-dimensional shape. A lyophilization fixture includes a base member and a lid member. The lid member is movable between a first position and a second position relative to the base member. The base member and lid member together define a housing that receives at least a portion of a lyophilization container.

### FIELD

The present disclosure generally relates to lyophilization, and more specifically, to containers and structures for lyophilization, and also to methods of using and making the same.

### BACKGROUND

This section provides background information related to the present disclosure which is not necessarily prior art.

Lyophilization (also referred to as freeze drying) includes processes used to preserve materials (including, for example, biological materials and/or foods and/or pharmaceuticals) to increase shelf life of the materials and also to improve transport and safe handling of the materials. Lyophilization commonly occurs by freezing the materials (the material is commonly a liquid at room temperature and pressure) to form solid materials and subjecting the solid materials to a low-pressure and low-temperature environment that is sufficient to take the solid material below its triple point. In the instance of water, for example, the triple point is the temperature (for example, about 0.01° C.) and pressure (for example, about 0.00603 atm) at which all three phases (i.e., vapor, liquid, and ice) of water can exist in equilibrium. Lyophilization is carried out below the triple point to enable conversion of ice into vapor without entering the liquid phase. This conversion from ice to vapor is known as sublimation.

Lyophilization of a fluid often occurs using a lyophilizer that includes a shelf system (for example, a hydraulic shelf system) configured to receive containers loaded with the fluid. In at least one example embodiment, the shelf system may be configured to receive a generally flexible lyophilization structure (e.g., bag) that defines the lyophilization container. In other example embodiments, the shelf system may be configured to receive a generally rigid, outer box (or fixture or structure) that is configured to receive and/or hold at least a portion of the generally flexible lyophilization structure (e.g., bag). The rigid, outer box and the generally flexible lyophilization structure may together define the lyophilization container. In still other example embodiments, the shelf system may be configured to receive a generally rigid frame that is configured to receive and/or hold at least a portion of the generally flexible lyophilization structure (e.g., bag). The rigid frame and the generally flexible lyophilization structure may together define the lyophilization container. The rigid frame may differ from the outer box in that the frame has a greater total surface area compared to the rigid outer box. It should be appreciated that, in various example embodiments, the rigid outer box and the rigid frame may be interchangeable.

In each instance, lyophilization of the fluid can be accelerated if the fluid is frozen into a relatively thin solid layer or layers (which may, in certain instances, also be referred to as an ice layer or ice layers) in the respective lyophilization container with notable headspace above the formed thin solid layers. The headspace allows vapor (for example, water vapor) to move freely away from the surface of the solid layers and towards and out of a sterile barrier vent during the sublimation process. In the instance where the lyophilization container includes a generally rigid, outer box and a generally flexible lyophilization structure, the desired geometry of the thin solid layers/ice layers is often achieved by introducing gas pressure causing the generally flexible lyophilization structure to inflate/stretch and conform to the outer, rigid box. Induced stress in the flexible films, which can be caused, for example, by the applied pressure, often causes various failure modes, including in a peel seal often used to separate and/or distinguish and/or temporarily occlude sections of the generally flexible lyophilization structure. Accordingly, it would be desirable to develop improved materials, processes, and means for freeze drying/lyophilizing fluids.

### SUMMARY

This section provides a general summary of the disclosure and is not a comprehensive disclosure of its full scope or all of its features.

In various aspects, the present disclosure provides an example lyophilization container.

In at least one example embodiment, the lyophilization container may include a first section that include a first layer, a second layer aligned with the first layer, and a cavity defined by the alignment of the first and second layers, where at least one of the first and second layers may be preformed to have a three-dimensional shape.

In at least one example embodiment, the selected three-dimensional shape may include a planar surface and side angled away from the planar surface.

In at least one example embodiment, the sides may be substantially perpendicular to the planar surface.

In at least one example embodiment, the three-dimensional shape may have an open-box configuration.

In at least one example embodiment, the planar surface may be a first planar surface, the first layer may include the three-dimensional shape, and the second layer may include a second planar surface, where the second planar surface may be coupled to the sides of the three-dimensional shape to define the cavity.

In at least one example embodiment, the three-dimensional shape may be a first three-dimensional shape, the first layer may include the first three-dimensional shape, and the second layer may include a second three-dimensional shape.

In at least one example embodiment, the first and second three-dimensional shapes may be the same.

In at least one example embodiment, the first three-dimensional shape may include a first planar surface and first sides angled away from the first planar surface, and the second three-dimensional shape may include a second planar surface and second sides angled away from the second planar surface. The first and second planar may be substantially parallel. The first and second sides may be coupled together to define the cavity.

In at least one example embodiment, the first and second layers may be different parts of a continuous sheet.

In at least one example embodiment, the cavity may be a first cavity, and the lyophilization container may further include a second section that includes a third layer, a fourth layer aligned with the third layer, and a second cavity defined by the alignment of the third and fourth layers, where at least one of the third and fourth layers includes a breathable membrane.

In at least one example embodiment, the third and fourth layers may be different parts of a continuous sheet.

In at least one example embodiment, one of the first and second sections of the lyophilization container may include one or more apertures for securing the lyophilization container to a lyophilization fixture.

In at least one example embodiment, the lyophilization fixture may include a first portion configured to support the first portion of the lyophilization container and a second portion configured to support the second portion of the lyophilization container, where the first portion includes a base and a movable lid that together define a housing that receives the first portion of the lyophilization container.

In at least one example embodiment, the lyophilization container may further include an occluding section disposed between the first section and the second section, where the occluding section may be movable between a first configuration and a second configuration. The occluding section in the first configuration may prevent liquid movement between the first and second cavities. The occluding section in the second configuration may allow for liquid movement between the first and second cavities.

In various aspects, the present disclosure provides an example method for forming a lyophilization container.

In at least one example embodiment, the method may include heating a sheet to a pliable temperature, disposing the sheet on or near a surface of a mold structure including a portion shaped to mold the sheet to form a layer having an open box configuration, and cooling the layer to form the lyophilization container, where the open box configuration may include a planar surface and sides angled away from the planar surface.

In at least one example embodiment, the layer may be a first layer, the portion may be a first portion, the mold structure may further include a second portion shaped to mold the sheet to form a second layer continuous with the first layer, and the method may further include aligning the second layer with the first layer to define a cavity.

In at least one example embodiment, the open box configuration may be a first open box configuration, the planar surface may be first planar surface, the sides may be first sides, the second layer may have a second open box configuration, the second open box configuration may include a second planar surface and second sides angled away from the second planar surface, and the method may further include joining together the first and second sides together to enclose the cavity.

In at least one example embodiment, the method may include using a vacuum to mold the sheet to form the layer having the open box configuration.

In at least one example embodiment, the sheet may be a first sheet, the pliable temperature may be a first pliable temperature, the mold may be a first mold, the layer may be a first layer, the open box configuration may be a first open box configuration, the planar surface may be a first planar surface, the sides may be first sides, and the method may further include heating a second sheet to a second pliable temperature, disposing the second sheet on or near a surface of a second mold structure including a portion shaped to mold the sheet to form a second layer having a second open box configuration, and joining together the first and second sides together to enclose the cavity. The second open box configuration may include a second planar surface and second sides angled away from the second planar surface.

In various aspects, the present disclosure provides an example method of using a lyophilization container.

In at least one example embodiment, the method may include obtaining a lyophilization container, the lyophilization container including a first section and a second section. The first section of the lyophilization container may include a first layer, a second layer aligned with the first layer, and a cavity defined by the alignment of the first and second layers, where at least one of the first and second layers may be preformed to have a three-dimensional shape. The second section of the lyophilization container may include a third layer, a fourth layer aligned with the third layer, and a second cavity defined by the alignment of the third and fourth layers, where at least one of the third and fourth layers may include a breathable membrane. The method may further include disposing the lyophilization container in a lyophilization fixture. The lyophilization fixture may include a first portion configured to support the first portion of the lyophilization container and a second portion configured to support the second portion of the lyophilization container. The first portion may include a base and a movable lid that together define a housing that receives the first portion of the lyophilization container.

In various aspects, the present disclosure provides an example lyophilization fixture.

In at least one example embodiment, the lyophilization fixture may include a base member and a lid member. The lid member may be movable between a first position and a second position relative to the base member. The base member and lid member may together define a housing that receives at least a portion of a lyophilization container.

In at least one example embodiment, the lid member may include two or more lid coupling members, and the base member may include two or more base coupling members. Each of the two or more base coupling members may include slots configured to receive at least a portion of the corresponding lid coupling member.

In at least one example embodiment, the two or more lid coupling members may include a first pair of lid coupling members and a second pair of lid coupling members, the first pair of lid coupling members may be disposed on a first side of the lid, and the second pair of lid coupling members may be disposed on a second side of the lid.

In at least one example embodiment, the two or more base coupling members may include a first pair of base coupling members and a second pair of base coupling members. The first pair of base coupling members may be disposed on a first side of the base member and configured to receive at least a portion of the first pair of lid coupling members. The second pair of lid coupling members may be disposed on a second side of the base member and configured to receive at least a portion of the second pair of lid coupling members.

In at least one example embodiment, the first pair of base coupling members and the first pair of lid coupling members may define a hinge that allows for movement of the lid member between the first position and the second position.

In at least one example embodiment, the hinge may be a first hinge, and the second pair of base coupling members and the second pair of lid coupling members may together define a second hinge that allows for movement of the lid member between the first position and a third position.

In at least one example embodiment, the base member and the lid member may together define a first portion of the lyophilization fixture, the portion of the lyophilization container may be a first portion of the lyophilization container, and the lyophilization fixture may further include a second portion. The second portion may include a frame member configured to support a second portion of the lyophilization container.

In at least one example embodiment, the frame member may include a first section having a first major plane and a second section having a second major plane that is separated from the first major plane.

In at least one example embodiment, the frame member may further include a third section that joins together the first section and the second section.

In at least one example embodiment, the second member may be continuous with the base member of the first portion.

In at least one example embodiment, the second portion may further include one or more couplers for engaging the lyophilization container.

In at least one example embodiment, the two or more couplers may be disposed at a distal portion of the second portion away from the first portion.

In at least one example embodiment, the lyophilization container may include a first section to be received by the first portion of the lyophilization fixture and a second section to be received by the second portion of the lyophilization fixture. The first section of the lyophilization container may include a first layer, a second layer aligned with the first layer, and a cavity defined by the alignment of the first and second layers, where at least one of the first and second layers may be preformed to have a three-dimensional shape. The second section of the lyophilization container may include a third layer, a fourth layer aligned with the third layer, and a second cavity defined by the alignment of the third and fourth layers, where at least one of the third and fourth layers may include a breathable membrane.

In various aspects, the present disclosure provides another example lyophilization fixture.

In at least one example embodiment, the lyophilization fixture may include a first portion and a second portion. The first portion may include a base member and a lid member removable from and couplable to the base member. The lid member may be movable between a first position and a second position. The base member and lid member may together define a housing that receives a non-breathable portion of a lyophilization container. The second portion may include a frame member configured to support a breathable portion of the lyophilization container. The frame member may include a first section continuous with the base member and a second section separated therefrom.

In at least one example embodiment, the lid member may include two or more lid coupling members and the base member includes two or more base coupling members. Each of the two or more base coupling members may include slots configured to receive at least a portion of the corresponding lid coupling member.

In at least one example embodiment, the two or more lid coupling members may include a first pair of lid coupling members and a second pair of lid coupling members. The first pair of lid coupling members may be disposed on a first side of the lid, and the second pair of lid coupling members may be disposed on a second side of the lid.

In at least one example embodiment, the two or more base coupling members may include a first pair of base coupling members and a second pair of base coupling members. The first pair of base coupling members may be disposed on a first side of the base member and configured to receive at least a portion of the first pair of lid coupling members, and the second pair of lid coupling members may be disposed on a second side of the base member and configured to receive at least a portion of the second pair of lid coupling members.

In at least one example embodiment, the first pair of base coupling members and the first pair of lid coupling members may define a hinge allowing for movement of the lid member between the first position and the second position.

In at least one example embodiment, the hinge may be a first hinge, and the second pair of base coupling members and the second pair of lid coupling members may define a second hinge allowing for movement of the lid member between the first position and a third position.

In at least one example embodiment, the frame member may further include a third section that joins together the first section and the second section.

In various aspects, the present disclosure provides a method of using a lyophilization fixture.

In at least one example embodiment, the method may include aligning a first portion of a lyophilization container with a first portion of the lyophilization fixture and aligning a second portion of the lyophilization container with a second portion of the lyophilization fixture. The first portion of the lyophilization fixture may include a base member and a lid member removable from and couplable to the base member. The lid member may be movable between a first position and a second position. The base member and lid member may together define a housing that receives a non-breathable portion of a lyophilization container. The second portion of the lyophilization fixture may include a frame member configured to support a breathable portion of the lyophilization container. The frame member may include a first section continuous with the base member and a second section separated therefrom.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is an illustration of an example lyophilizer including a shelfing structure in accordance with at least one example embodiment of the present disclosure;

FIG. 2 is an illustration of another example lyophilizer including a shelfing structure in accordance with at least one example embodiment of the present disclosure;

FIG. 3 is an illustration of an example shelfing structure in accordance with at least one example embodiment of the present disclosure;

FIG. 4 is a top-down perspective view of an example lyophilization container including one or more preformed portions, for example, for use with the example lyophilizers illustrated in FIGS. 1 and 2 and/or the example shelfing structure illustrated in FIG. 3, in accordance with at least one example embodiment of the present disclosure;

FIG. 5 is a plan view of a first side of the example lyophilization container including the one or more thermoformed portions as illustrated in FIG. 4;

FIG. 6 a plan view of a second side of the example lyophilization container including the one or more thermoformed portions as illustrated in FIG. 4;

FIG. 7 is a side perspective view of the example lyophilization container including the one or more thermoformed portions as illustrated in FIG. 4;

FIG. 8 is a cross-sectional view of the example lyophilization container including the one or more thermoformed portions as illustrated in FIG. 4;

FIG. 9 is another cross-sectional view of the example lyophilization container including the one or more thermoformed portions as illustrated in FIG. 4;

FIG. 10 is an exploded view of the example lyophilization container including the one or more thermoformed portions as illustrated in FIG. 4;

FIG. 11 is a schematic illustrating an example method of forming one or more sections of a lyophilization container, including, for example, the lyophilization container including the one or more thermoformed portions as illustrated in FIG. 4, in accordance with at least one example embodiment of the present disclosure;

FIG. 12 is a perspective view of a first side of an example fixture (in a first (or closed) position), for example, for use with the example lyophilizers illustrated in FIGS. 1 and 2 and/or the example shelfing structure illustrated in FIG. 3 and/or the lyophilization container illustrated in FIGS. 4-10, in accordance with at least one example embodiment of the present disclosure;

FIG. 13 is a perspective view of a second side of the example fixture illustrated in FIG. 12 in accordance with at least one example embodiment of the present disclosure;

FIG. 14 is a perspective view of the example fixture illustrated in FIGS. 12 and 13 in a second (or opened) position in accordance with at least one example embodiment of the present disclosure;

FIG. 15 is a perspective view of the example fixture illustrated in FIGS. 12 and 13 holding a generally flexible assembly, like the lyophilization container illustrated in FIGS. 4-10, in accordance with at least one example embodiment of the present disclosure;

FIG. 16 is a perspective view of the example fixture illustrated in FIG. 14 holding a generally flexible assembly, like the lyophilization container illustrated in FIGS. 4-10, in accordance with at least one example embodiment of the present disclosure;

FIG. 17 is a perspective view of a first side of another example fixture (in an opened position), for example, for use with the example lyophilizers illustrated in FIGS. 1 and 2 and/or the example shelfing structure illustrated in FIG. 3 and/or the lyophilization container illustrated in FIGS. 4-10, in accordance with at least one example embodiment of the present disclosure; and

FIG. 18 is a flowchart illustrating an example lyophilization process, for example, using the example lyophilizers illustrated in FIGS. 1 and 2 and/or the example shelfing structure illustrated in FIG. 3 and/or the example lyophilization container illustrated in FIGS. 4-10, in accordance with at least one example embodiment of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Various components are referred to herein as “operably associated.” As used herein, “operably associated” refers to components that are linked together in operable fashion and encompasses embodiments in which components are linked directly, as well as embodiments in which additional components are placed between the linked components. “Operably associated” components can be “fluidly associated.” “Fluidly associated” refers to components that are linked together such that fluid can be transported between them. “Fluidly associated” encompasses embodiments in which additional components are disposed between the two fluidly associated components, as well as components that are directly connected. Fluidly associated components can include components that do not contact fluid but contact other components to manipulate the system (e.g., a peristaltic pump that pumps fluids through flexible tubing by compressing the exterior of the tube).

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some example embodiments, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments will now be described more fully with reference to the accompanying drawings.

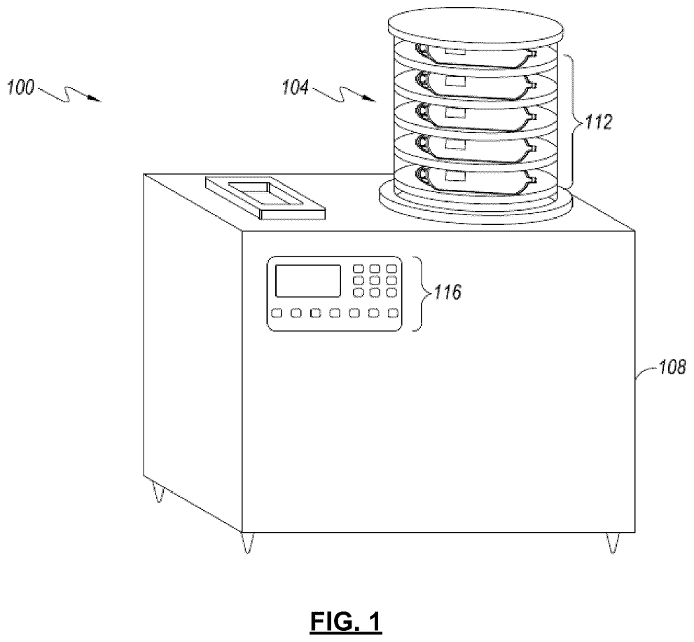

FIG. 1 illustrates an example apparatus 100 for lyophilizing materials, including, for example, biological materials and/or foods and/or pharmaceuticals in the form of liquids, solids, or combinations thereof, to increase shelf life of the materials and also to improve transport and safe handling of the materials.

The apparatus 100 includes a chamber 104 encompassing a shelfing structure (which may also be referred to as a shelfing system) 112 configured to hold the materials to be lyophilized and a housing 108 in communication with the chamber. The housing 108 may include, for example, at least one of a vacuum system (not shown) configured to create a low-pressure environment in the chamber 104, a temperature control system (not shown) configured to control the temperature of the shelfing structure 112, a vapor condensing system (not shown) configured to collect and hold sublimating vapor leaving the chamber 104, and a control system (not shown) including, for example, a computer system having one or more processors for controlling various functions of the apparatus. The housing 108 may include, for example, a user interface 116. The user interface 116 may be configured to allow an operator to input data, parameters, and other information to control certain functions of the apparatus 100. For example, the user interface 116 may permit the operator to communicate with the control system to create and execute custom processes for lyophilizing different materials, including multi-step programmable cycles.

The material to be lyophilized may be placed onto the different shelves of the shelfing structure 112. The temperature control system disposed in the housing 108 and configured to alter the temperature of the shelfing structure 112 may then be used to first freeze the material to be lyophilized and then to further reduce the temperature of the frozen material to a predetermined level which may be, for example, the temperature to be maintained during the sublimation phase of the lyophilization cycle. For example, in the instance of water sublimation, the temperature may be selected to be below the triple point so as to help preserve materials suspended or dissolved in the aqueous solution. For example, in at least one example embodiment, the predetermined level may include temperatures greater than or equal to about −30° C. to less than or equal to about −20° C.

After the material to be lyophilized is frozen and is further cooled to the predetermined temperature, the vacuum system disposed in the housing 108 and configured to alter the pressure within the chamber 104 may be used to bring the environment in the chamber 104 to a pressure that is lower than atmospheric pressure. For example, in at least one example embodiment, the pressure might be lowered to and maintained below an absolute pressure of less than about 100 milli-Torr for a duration of a sublimation period. The sublimation phase or period includes the time lapse between the start of sublimation and the end of sublimation. Sublimation begins as the pressure and temperature in chamber 104 create a chamber environment that is lower than the triple point. Sublimation ends when all ice has been removed from the material to be lyophilized. The sublimation period may vary depending on the material to be lyophilized, quantity of the material to be lyophilized, and the shape, for example, the thickness, of the material to be lyophilized.

In at least one example embodiment, the vacuum system may work in cooperation with the vapor condenser system to maintain an environment within the chamber 104 at a pressure that is the lower than atmospheric pressure. As sublimation takes place at the low chamber pressure, the escaping vapor can carry heat energy away from the material to be lyophilized. The escaping vapor may then be captured onto the vapor condenser system contained within housing 108. The continuous capture of sublimating vapors by the vapor condenser system can help to maintain the low chamber pressure within the sublimating chamber 104. The control system contained within housing 108 may be programmed to control temperature of the shelving structure 112 such that the escaping heat energy is replaced, and the shelving structure may be maintained at a temperature sufficient to sustain sublimation until all volatile substances have been removed from the material to be lyophilized. Following sublimation of essentially all volatile material components and/or other material component(s) (i.e., end of the sublimation period), an increased shelf temperature may be set and maintained for an additional period of time to desorb one or more other material components from the material to be lyophilized. The one or more other material may have been previously absorbed or absorbed by the material. Once desorption is complete, pressure within the chamber may be returned to atmospheric pressure and the now completely dried product may be harvested.

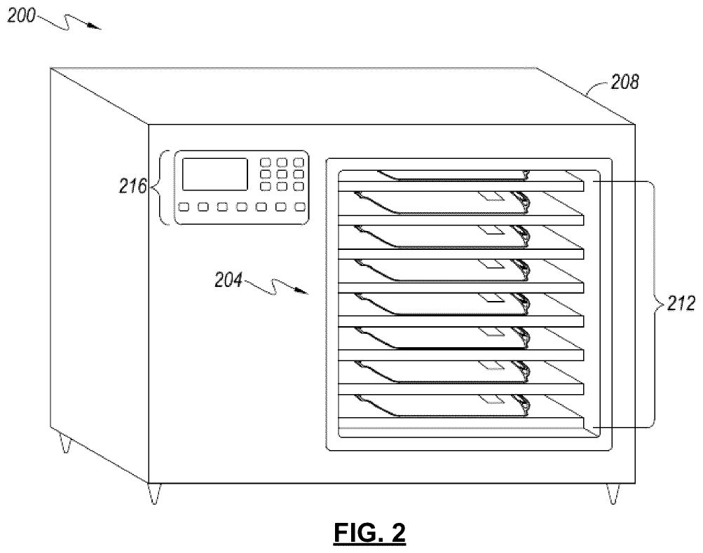

FIG. 2 illustrates another example apparatus 200 for lyophilizing materials including, for example, biological materials and/or foods and/or pharmaceuticals in the form of liquids, solids, or combinations thereof to increase shelf life of the materials and also to improve transport and safe handling of the materials. The apparatus 200 is similar to the apparatus 100, however, in the instance of apparatus 200 the chamber 204 may be disposed within the housing 208. Like the chamber 104, the chamber 204 may be configured to include a shelfing structure (or system) 212 configured to hold the materials to be lyophilized. Also, like the housing 108, the housing 208 may include a user interface 216 configured to allow an operator to input data, parameters, and other information to control certain functions of the apparatus 200.

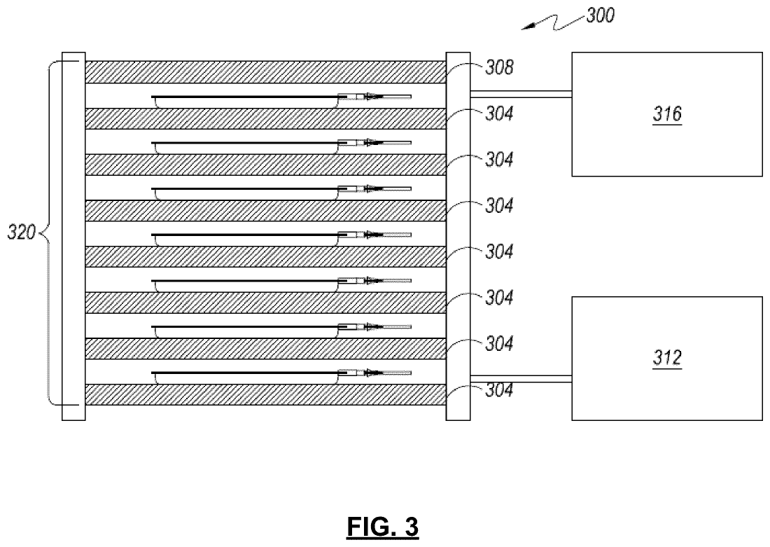

FIG. 3 illustrates an example shelfing structure 320 that may be used for various lyophilization processes, including as shelfing structures 112 and 212 for the lyophilizers 100, 200 illustrated in FIGS. 1 and 2, respectively. The shelfing structure 320 includes a plurality of plates 304 extending between and movable along a pair of side rails 322, 324. Each plate 304 defines a surface 326 for placing a material to be lyophilized. In certain variations, depending on the type of material to be lyophilized, the material may be maintained within a container 328 (such as a fixture, tray, bag, or bottle) and the container 328 placed on the plate 304, as illustrated.

The containers 328 may be like those described in U.S. Pat. No. 11,747,082 titled MULTI-PART LYOPHILIZATION CONTAINER AND METHOD OF USE, issued Sep. 5, 2023, and listing Kestas P. Parakininkas, Eric T. Hansen, Kirk L. Weimer, Nathaniel T. Johnson, and Dennis J. Hlavinka as co-inventors and/or U.S. Pat. No. 11,609,042 titled MULTI-PART LYOPHILIZATION CONTAINER AND METHODS OF USE, issued Mar. 21, 2023, and listing Kestas P. Parakininkas, Eric T. Hansen, Kirk L. Weimer, Nathaniel T. Johnson, and Dennis J. Hlavinka as co-inventors and/or U.S. Pat. No. 10,793,327 titled LYOPHILIZATION CONTAINER AND METHOD OF USING THE SAME, issued on Oct. 6, 2022, and listing Kirk L. Weimer, Nate T. Johnson, Dennis J. Hlavinka, and Kestas P. Parakininkas as co-inventors and/or U.S. Pat. No. 11,634,257 titled LYOPHILIZATION CONTAINER AND METHOD OF USING SAME, issued Apr. 25, 2023 and listing Kirk L. Weimer, Nate T. Johnson, Dennis J. Hlavinka, and Kestas P. Parakininkas as co-inventors and/or U.S. Pat. No. 11,609,043, titled LYOPHILIZATION CONTAINER FILL FIXTURE, SYSTEM AND METHOD OF USE, issued on Mar. 21, 2023 and listing Nathaniel T. Johnson, Rylan A. Summit, Dennis A. Bridges, Dennis J. Hlavinka, Kestas P. Parakininkas, Kirk L. Weimer, Michael Lawrence Glover, Alexander Du Nguyen, and Margaret V. Kwiat as co-inventors, the entire disclosures of which are hereby incorporated by reference.

For example, in at least one example embodiment, the containers 328 may be generally flexible containers, including, for example, bags and/or trays. In other example embodiments, the containers 328 may include generally rigid fixtures (or structures or frames or boxes) configured to receive at least a portion of a bag (or another generally flexible structure) that carries (or holds) the material to be lyophilized. In such instances, the generally rigid fixture may be sized to receive, contain, and confine the bag throughout the lyophilization process. In at least one example embodiment, the fixture may include one or more sealing structures configured to retain the bag within the fixture. In at least one example embodiment, the fixture may be configured to receive an empty bag and once positioned the material to be lyophilized may be added to the bag. Gas, including, for example, air or nitrogen, may then be introduced into the bag to ensure that the bag conforms to the dimensions of the fixture. The generally ridged fixture may include, or be formed, as detailed, for example, in U.S. Pat. No. 11,609,043, titled LYOPHILIZATION CONTAINER FILL FIXTURE, SYSTEM AND METHOD OF USE, issued on Mar. 21, 2023 and listing Nathaniel T. Johnson, Rylan A. Summit, Dennis A. Bridges, Dennis J. Hlavinka, Kestas P. Parakininkas, Kirk L. Weimer, Michael Lawrence Glover, Alexander Du Nguyen, and Margaret V. Kwiat as co-inventors, the entire disclosure of which is hereby incorporated by reference. The assembly (including the generally rigid fixture and the bag including the material to be lyophilized) may undergo a lyophilization cycle as detailed above

With renewed reference to FIG. 3, in at least one example embodiment, the shelfing structure 320 may also include an end plate 308 parallel with the plates 304 and also extending between the pair of rails 322, 324. The end plate 308 may be a stationary plate. The shelfing structure 320 may include a movement control system 312 that may be configured to cause the distance between the plates 304 to be varied. For example, the distance between the plates 304 may be varied to interact with the containers 328 during the lyophilization process. In at least one example embodiment, interaction with the containers 328 may include, for example, closing the container 328 upon completion of the lyophilization process. The movement control system 312 may include a variety of components that work together to move the plates 304. For example, in at least one example embodiment, the movement control system 312 may include a computer system or systems that include memory, input devise, output device, communication devices, subsystems, or any combination thereof. The subsystems may include, for example, hydraulic, pneumatic, or mechanical systems. The hydraulic, pneumatic, or mechanical systems may include, for example, motors, actuators, pumps, compressors, cylinders, pistons, tubing, valves, bladders, sensors, regulators, or any combination thereof. The movement control system 312 may be removably coupled to the plates 304 using any appropriate connections, including, for example, connectors, tubings, fittings, pipes, and/or adapters.

The shelfing structure 320 may also include a thermal fluid system 316 that may be configured to circulate a thermal fluid through and/or around at least a portion of the plurality of plates 304. For example, in at least one example embodiment, the thermal fluid system 316 may be removably coupled to the plates 304 using any appropriate connections, including, for example, connectors, tubings, fittings, pipes, adapters, or any combination thereof. In each instance, the movement of the thermal fluid may be used to remove and/or add energy to at least a portion of the plurality of plates 304. For example, the movement of the thermal fluid may be used to control the temperature of one or more of the plurality of plates and the materials for lyophilization disposed on the plates.

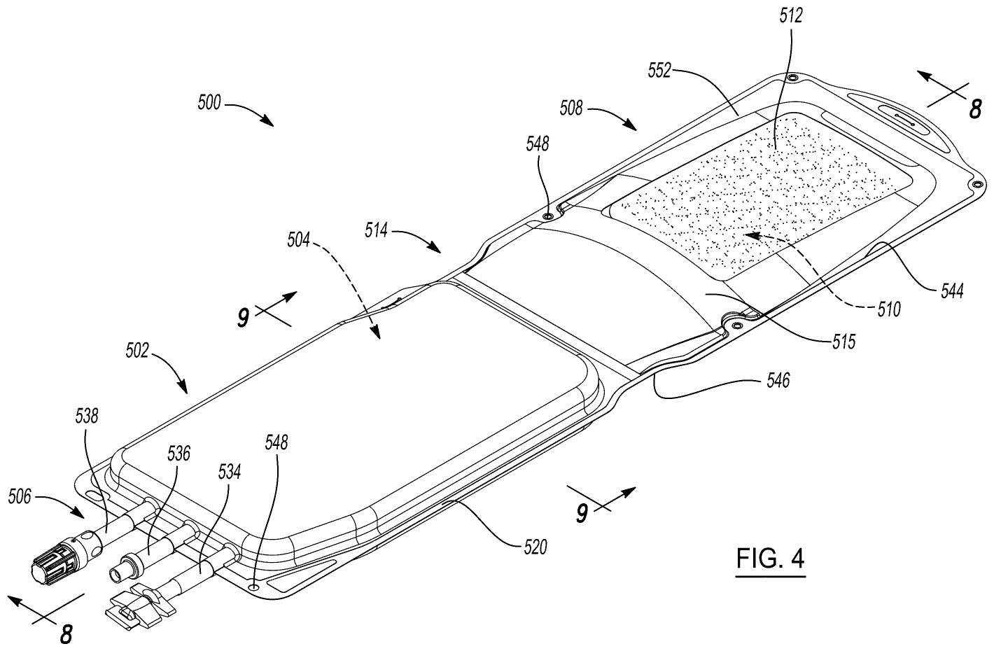

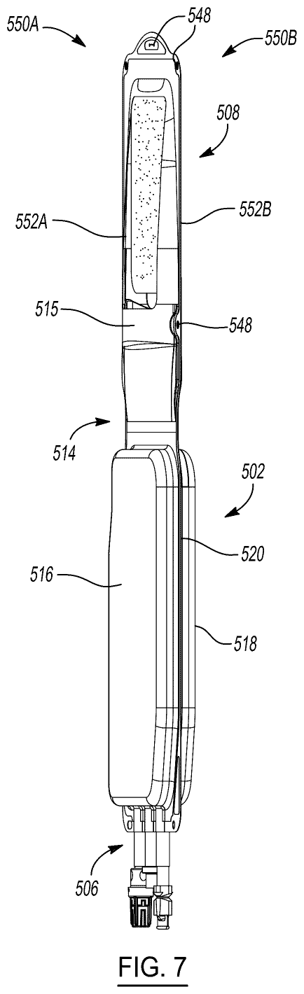

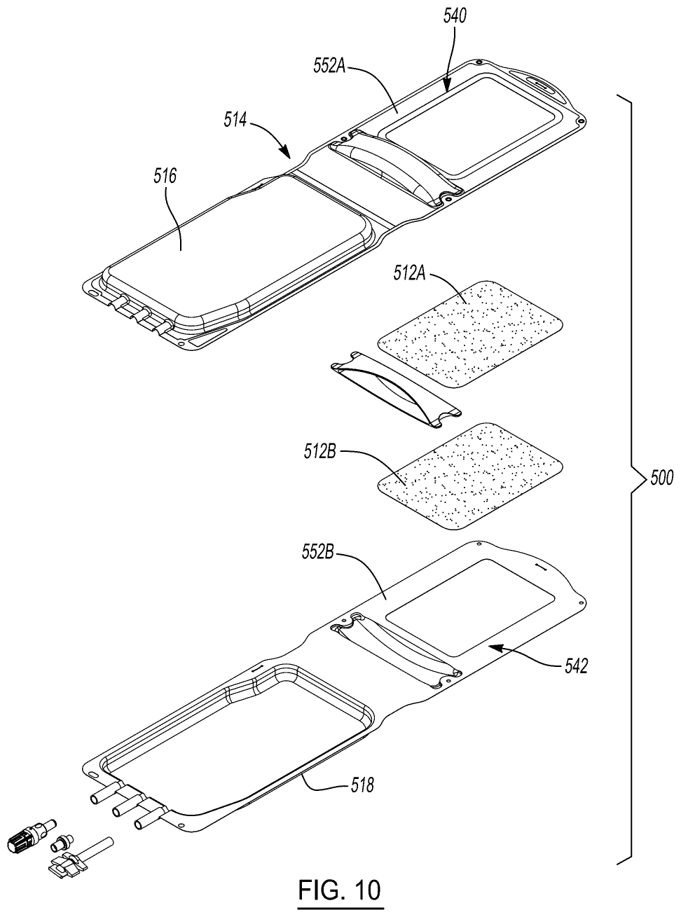

At least some example embodiments of the present disclosure provides lyophilization containers, for example, for use with the example lyophilizers illustrated in FIGS. 1 and 2 and/or the example shelfing structure illustrated in FIG. 3 as the container 328. FIGS. 4-10 provide different views of an example lyophilization container 500. In at least one example embodiment, the lyophilization container 500 includes a first section (or region or portion or zone) (which may also be referred to as the non-breathable section (or region or portion or zone)) 502 and a second section (or region or portion or zone) (which may also be referred to as the breathable section (or region or portion or zone)) 508. The first section 502 may include a first pocket (or cavity or space) 504 and a port region 506. The second section 508 may include a second pocket (or cavity or space) 510 and a breathable membrane 512. The second pocket 510 may have a non-descript shape or configuration that may be substantially flat in an un-used or un-filled state, while the first pocket 504 has three-dimensional, pre-form shape.

The breathable membrane 512 of the second section 508 may include (or be formed from) a microbial barrier porous material that allows the passage of small molecules, such as water vapor, nitrogen, carbon dioxide, or any combination thereof. In contrast, the first section 502 may include (or be formed from) a polymeric film that has no discernable pore structure to allow vapor transfer. In at least one example embodiment, the microbial barrier porous material may have an average pore size greater than or equal to about 0.15 micrometers to less than or equal to about 0.5 micrometers (e.g., optionally about 0.22 micrometers or optionally about 0.45 micrometers). In at least one example embodiment, the microbial barrier porous material may include polytetrafluoroethylene (PTFE), polypropylene, polyethylene, polyester, or any combination thereof.

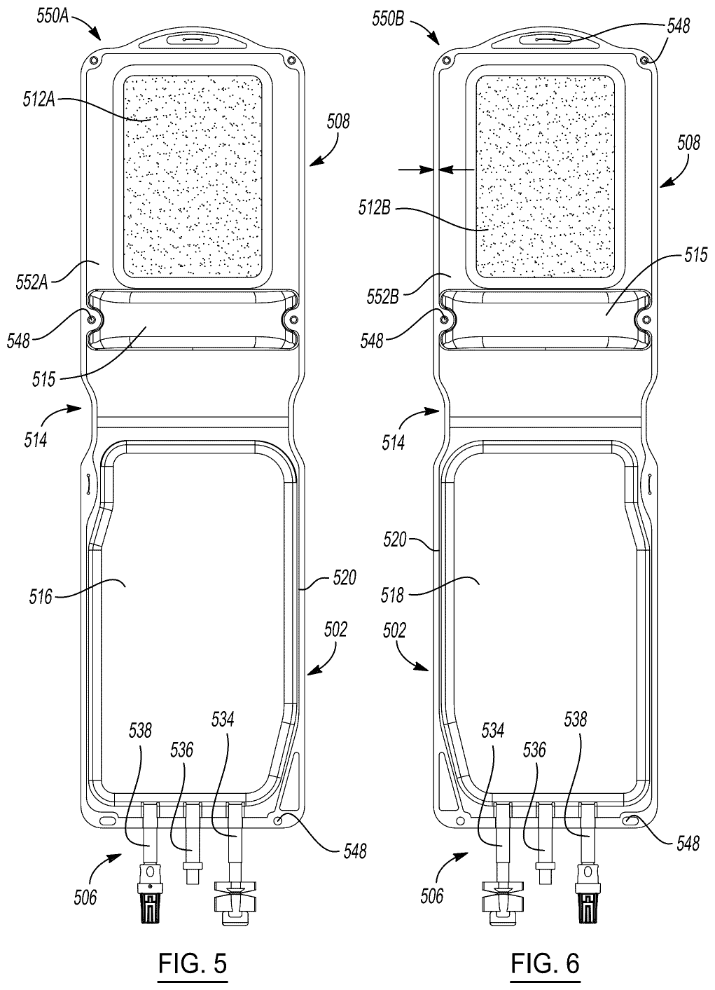

In at least one example embodiment, the top (or front) 550A of the lyophilization container 500 (for example, as illustrated in FIG. 5) may be substantially identical to the bottom (or back) 550B of the lyophilization container 500 (for example, as illustrated in FIG. 6). In at least one example embodiment, the lyophilization container 500 may be placed on a lyophilizer shelf (or other lyophilizer) such that the bottom 550B of the lyophilization container 500 (or alternatively, the top 550A of the lyophilization container 500) faces the lyophilizer shelf (or other lyophilizer) and during lyophilization a portion of each of the first section 502 and the second section 508 faces the lyophilizer shelf (or other lyophilizer). In other example embodiments, the lyophilization container 500 may be placed on a lyophilizer shelf (or other lyophilizer) such that the bottom 550B of the lyophilization container 500 (or alternatively, the top 550A of the lyophilization container 500) faces the lyophilizer shelf (or other lyophilizer) and during lyophilization a portion of only the first section 502 faces the lyophilizer shelf (or other lyophilizer) while the second section resides elsewhere. In each instance, the first section 502 may be configured and positioned to maintain sufficient direct or thermal communication with the lyophilizer shelf (or other lyophilizer) to help facilitate conductive and/or radiative heat transfer.

In at least one example embodiment, the first section 502 includes a first sheet (or layer or film) 516 that overlaps with and may be parallel to a second sheet (or layer or film) 518, where one or more portions of the first and second sheets 516, 518 are connected or sealed (for example, heat welded and/or radio frequency welded) to define a first perimeter 520 and also the first enclosed cavity 504. Although two, separate sheets (or layers or films) are discussed, it should be appreciated that, in at least one example embodiment, the first section 502 may include (or be formed from) a continuous sheet (or layer or film) that may be folded along one or more portions to define the first cavity 504 and also parallel first and second portions corresponding with the herein described first and second sheets 516, 518.

In at least one example embodiment, at least one of the first and second sheets 516, 518 may be preformed to have a selected three-dimensional shape, such that at least one surface of the lyophilization container 500 has, for example, improved contact with a shelfing structure (for example, such as the shelfing structure 112 illustrated in FIG. 1 and/or the shelfing structure 212 illustrated in FIG. 2 and/or the shelfing structure 320 illustrated in FIG. 3) and/or that at least a portion of the lyophilization container 500 readily conforms to a rigid, outer box (or fixture or structure or frame). In at least one example embodiment, for example, as illustrated, the first and second sheets 516, 518 both are preformed. However, it should be appreciated, that in other example embodiments, only one of the first and second sheets 516, 518 and/or a portion thereof may be performed.

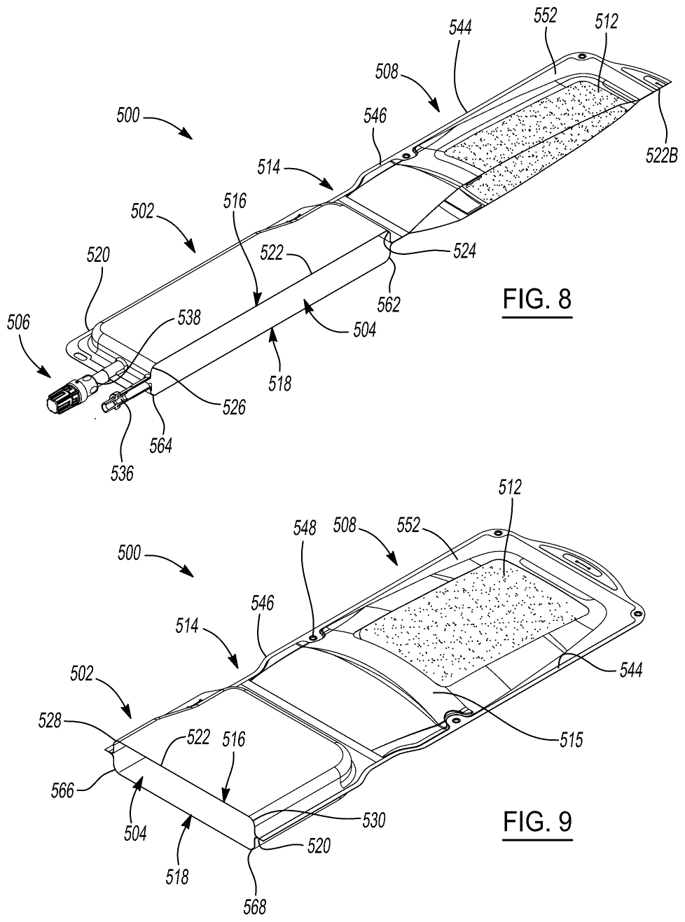

In at least one example embodiment, the first sheet 516 may have a first three-dimensional shape. As best illustrated, for example, in FIGS. 8 and 9, the first sheet 516 may have a general box-like (or rectangular-like) shape having a first substantially planar surface 522 where opposing first and second ends (or regions or portions) 524, 526 of the first substantially planar surface 522 are angled away from the first planar surface 522 and also where opposing first and second sides (or regions or portions) 528, 530 of the first substantially planar surface 522 are angled away from the first planar surface 522. The three-dimensional shape may be selected such that the first sheet 516 readily conforms to a rigid, outer box (or fixture or structure or frame). For example, the three-dimensional shape may have a general open box configuration, where the angles are nearly (or substantially) perpendicular. As used herein, nearly (or substantially) perpendicular should be understood as being as close to perpendicular as allowed by manufacturing limitations, as recognized by the skilled artisan. In at least one example embodiment, the radii between the tops and bottoms of the slopes of the first and second ends 524, 526 and also the first and second sides 528, 530 may be minimized in order to maximize surface contact of first sheet 516 with the rigid, outer box. The aspect ratio between the tops and bottoms of the slopes of the first and second ends 524, 526 and also the first and second sides 528, 530 may be maximized to minimize the height of the ice formed therein.

In at least one example embodiment, the second sheet 518 may have a first three-dimensional shape. As best illustrated, for example, in FIGS. 8 and 9, the second sheet 518 may have a general box-like (or rectangular-like) shape having a second substantially planar surface 560, where opposing first and second ends (or regions or portions) 562, 564 of the second substantially planar surface 560 are angled away from the second planar surface 560 and also where opposing first and second sides 566, 568 of the second substantially planar surface 560 are angled away from the second planar surface 560. The three-dimensional shape may be selected such that the second sheet 518 readily conforms to a rigid, outer box (or fixture or structure). For example, the three-dimensional shape may have a general open box configuration, where the angles are nearly (or substantially) perpendicular. In at least one example embodiment, the radii between the tops and bottoms of the slopes of the first and second ends 562, 564 and also the first and second sides 566, 568 may be minimized in order to maximize surface contact of second sheet 518 with the rigid, outer box. The aspect ratio between the tops and bottoms of the slopes of the first and second ends 562, 564 and also the first and second sides 566, 568 may be maximized to minimize the height of the ice formed therein.

In at least one example embodiment, the first and second ends 524, 526 of the first substantially planar surface 522 may be joined to the respective portions of the corresponding second sheet 518 (e.g., the first and second ends 562, 564). In at least one example embodiment, first and second sides 528, 530 of the first substantially planar surface 522 may be joined to the respective portions of the corresponding second sheet 518 (e.g., the first and second sides 566, 568).

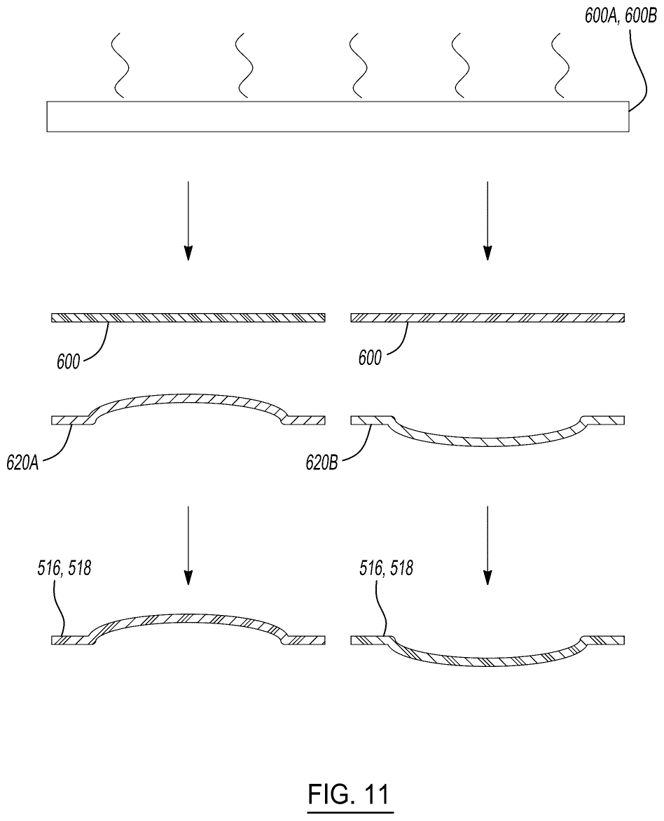

As discussed above, the first and second sheets 516, 518 may include non-breathable, polymeric sheets (or layers or film). In at least one example embodiment, the first and second sheets 516, 518 may include (or be formed of), for example, polyvinyl chloride (PVC), ethylene-vinyl acetate (EVA), polyethylene (PE), polypropylene (PP), thermoplastic elastomers (TPE), or other flexible polymeric film. The first and second sheets 516, 518 may be preformed using, for example, a thermoformed process, such as illustrated in FIG. 11, where precursor polymeric sheets 600A, 600B are heated 610 to a material-specific pliable temperature (i.e., a point at which the material beings to flow) and disposed (e.g., stretched) over and/or into a mold 620A, 620B to create the three-dimensional shape 516, 518.

With renewed reference to FIGS. 4-10, the port region 506 of the first section 502 includes one or more fluidic ports 534, 536, 538 configured to allow for fluid exchange with the first cavity 504. For example, in at least one example embodiment, as illustrated, the port region 506 may include three fluidic ports 534, 536, 538. However, it should be recognized that the number of ports 534, 536, 538 may vary depending on application. In each instance, the fluidic ports 534, 536, 538 are configured to provide for secure, sterile connections and to facilitate, for example, filing of the cavity 504, lyophilization using the lyophilization container 500, storage of the lyophilization container 500, reconstitution, and in the instance of lyophilized plasma, infusion.

In at least one example embodiment, one of the fluidic ports 534, 536, 538 may include (or be defined by) a spike port. In at least one example embodiment, one of the fluidic ports 534, 536, 538 may include (or be defined) by a docking port. In at least one example embodiment, one of the fluidic ports 534, 536, 538 may include (or be defined by) a reconstitution port. In at least one example embodiment, a first fluidic port of the one or more fluidic ports 534, 546, 538 may include a spike port and a second fluidic port of the one or more fluidic ports 534, 546, 538 may include a docking port. In at least one example embodiment, a first fluidic port of the one or more fluidic ports 534, 546, 538 may include a spike port and a second fluidic port of the one or more fluidic ports 534, 546, 538 may include a reconstitution port. In at least one example embodiment, a first fluidic port of the one or more fluidic ports 534, 546, 538 may include a docking port and a second fluidic port of the one or more fluidic ports 534, 546, 538 may include a reconstitution port. In at least one example embodiment, a first fluidic port of the one or more fluidic ports 534, 546, 538 may include a spike port, a second fluidic port of the one or more fluidic ports 534, 546, 538 may include a docking port, and a third fluidic port of the one or more fluidic ports 534, 546, 538 may include a reconstitution port.

In at least one example embodiment, a spike port may help to facilitate reinfusion of a reconstituted product (for example, a reconstituted blood product) into a subject (or patient or source). In at least one example embodiment, a docking port may help to facilitate connection between the lyophilization container 500 and another container, such as a blood pooling container or a pooling container set or a single unit of blood product. Additionally, or alternatively, the docking port may help to facilitate the introduction of air and/or gases into the lyophilization container 500. In at least one example embodiment, a reconstitution port may help to facilitate allow for an inflow of a reconstitution fluid into the lyophilization container 500. In at least one example embodiment, the reconstitution port may include one or more one-way valves and/or other methods to prevent contamination and to ensure proper connection.

In at least one example embodiment, the second section 508 includes a first sheet (or layer or film) 540 that overlaps with and may be substantially parallel to a second sheet (or layer or film) 542, where one or more portions of the first and second sheets 540, 542 are sealed (for example, heat welded) to define a second perimeter 544 and also the second enclosed cavity 508. Although two separate sheets or layers or films are discussed, it should be appreciated that, in at least one example embodiment, the second section 508 may include a continuous sheet (or layer or film) that may be folded along one or more portions to define the second cavity 510 and also parallel first and second portions corresponding with the herein described first and second sheets 540, 542.

The second section 508 includes a breathable region. In at least one example embodiment, at least one of the first and second sheets 540, 542 includes a breathable membrane 512 that may be embedded within, or joined to, a non-breathable, polymeric sheet (or layer or film) 552. For example, as illustrated, the first sheet 540 may include a first breathable membrane 512A and a first non-breathable, polymeric region 552A encompassing at least a portion of the first breathable membrane 512A, and the second sheet 542 may include a second breathable membrane 512B and a second non-breathable, polymeric region 552B encompassing at least a portion of the second breathable membrane 512B. In at least one example embodiment, the non-breathable, polymeric sheets 552 may include, for example, polyvinyl chloride (PVC), ethylene-vinyl acetate (EVA), polyethylene (PE), polypropylene (PP), or another flexible polymeric film. In at least one example embodiment, the breathable membrane 512 may include, for example, expanded polytetrafluoroethylene (PTFE), medical paper like that used in packaging, spun bonded polyolefin, or the like.

Although the first non-breathable, polymeric region 552A is illustrated as substantially surrounding the first breathable membrane 512A, it should be appreciated that, in other example embodiments, the first non-breathable, polymeric region 552A may surround only a portion of the first breathable membrane 512A, and further still, in other example embodiments, the first non-breathable, polymeric region 552A may be only disposed adjacent to the first breathable membrane 512A. Similarly, although the second non-breathable, polymeric region 552B is illustrated as substantially surrounding the second breathable membrane 512B it should be appreciated that, in other example embodiments, the second non-breathable, polymeric region 552B may surround only a portion of the second breathable membrane 512B, and further still, in other example embodiments, the second non-breathable, polymeric region 552B may be only disposed adjacent to the second breathable membrane 512B. Further, although not illustrated, it should be appreciated that, in still another example embodiment, only one of the first and second sheets 540, 542 includes a breathable region. Further, although not illustrated, it should be appreciated that, in still other example embodiments, the first and second sheets 540, 542 may be formed from a breathable membrane. Further still, although not illustrated, it should be appreciated, that in still other example embodiments, a breathable region may extend from the first sheet 540 to the second sheet 542.

In at least one example embodiment, the second perimeter 544 of the second section 508 may be joined to the first perimeter 520 of the first section 502 or formed integrally therewith to define an outer perimeter 546 of the lyophilization container 500. The outer perimeter 546 may have, for example, an average width greater than or equal to about 2 millimeters to less than or equal about 12 millimeters (e.g., optionally about 7 millimeters). In at least one example embodiment, as illustrated, the outer perimeter 546 (including the first perimeter 520 and/or the second perimeter 544) may include one or more apertures 548 configured, for example, for hanging the lyophilization container 500 and/or positioning (or securing) the lyophilization container 500 within a rigid, outer box or fixture or structure, as further discussed below.

In at least one example embodiment, the lyophilization container 500 further includes a third section (or region or portion or zone) (which may also be referred to as the peelable section or region and/or occluding section (or region or portion or zone)) 514 that extends between and joins the first and second sections 502, 508. The third section 514 may be adapted to facilitate the evolution of the lyophilization container 500 throughout its life cycle. For example, occlusion of the lyophilization container 500 in the third region 514, either initially by an intact peelable seal, or by subsequent occlusion (for example, using clamps) creates a temporary impermeable, or substantially impermeable seal, eliminating fluid communication between the first second 502 and the second section 508. Both prior to, and after, the sublimation and removal of vapor during lyophilization, the first and second sections 502, 508 should be isolated from one another.

In at least one example embodiment, the third section 514 may include a temporary peelable seal that when intact creates an initial occlusion that separates and isolates the first and second cavities 504, 510, for example, prior to and during the introduction of fluid via one or more of the fluidic ports 534, 536, 538. Once the fluid is frozen to form a frozen structure (which may also be referred to as a solid layer), a pressure differential may be generated, for example, by the application of a vacuum in a lyophilization chamber (like chamber 104 illustrated in FIG. 1 and/or chamber 204 illustrated in FIG. 2), resulting in an opening of the temporary peelable seal. In the open or unoccluded state, an open pathway for vapor flow exists between the first cavity 504 and the second cavity 510. The third section 514 may be again occluded, for example, by applying one or more clamps to the third section 514. For example, in at least one example embodiment, it may be desirable to occlude the lyophilization container 500 to prevent or limit gas from entering the lyophilization container 500.

In at least one example embodiment, the third section 514 may include a stent (or batten) 515. The stent 515 may be rigid enough to aid with holding the temporary peelable seal in the open state but also flexible enough to yield and flatten when the shelves of shelfing structure of a lyophilizers (e.g., the lyophilizers 100, 200 illustrated in FIGS. 1 and 2) are bought together, for example, at the end of a lyophilization cycle.

The ability of the lyophilization container 500 to continually evolve in form and function ensures that no contact occurs between the fluid and the breathable region of the second section 508 by causing the subject liquid to be isolated and frozen in only the first (non-breathable) section 502 and allowing the vapor flow from sublimation and desorption to flow into the breathable region of the second section 508 and exit the lyophilization container 500 through the breathable region. The lyophilization container 500 may be configured to create a physical separation between the subject fluid and the breathable region of the second region 510. The first section 502 may be adapted to accommodate any of a solid, a liquid, or a gas, while the second section 508 may be adapted to accommodate only gas. The third section 514 is further detailed, for example, in U.S. Pat. No. 11,609,042, titled MULTI-PART LYOPHILIZATION CONTAINER AND METHOD OF USE, issued on Mar. 21, 2023 and listing Kestas P. Parakininkas, Eric T. Hansen, Kirk L. Weimer, Nathaniel T. Johnson, and Dennis J. Hlavinka as co-inventors the entire disclosure of which is hereby incorporated by reference.

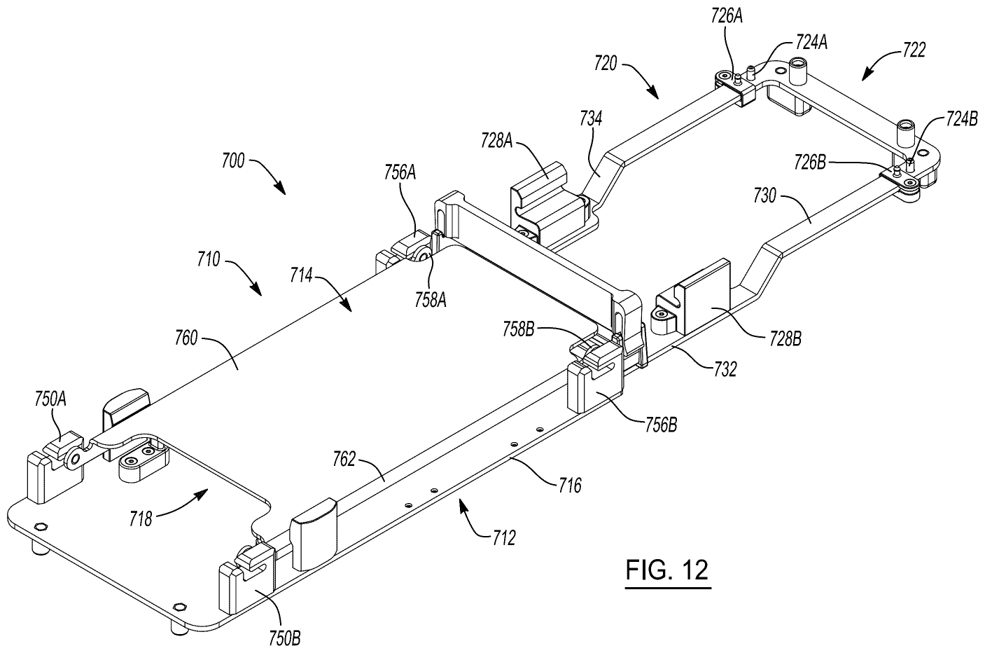

At least some example embodiments of the present disclosure provides a box (or fixture or structure or frame) that is configured to receive and/or hold at least a portion of a generally flexible lyophilization structure, for example, for use with the example lyophilizers illustrated in FIGS. 1 and 2 and/or the example shelfing structure illustrated in FIG. 3 and/or the example lyophilization container 500 illustrated in FIGS. 4-10. FIGS. 12-17 provide different views of an example lyophilization box (or fixture or structure) 700. As illustrated, the lyophilization fixture 700 includes a first portion 710 and a second portion 720. The first portion 710 may be configured to receive a first portion (or section) of a lyophilization container to be supported by the lyophilization fixture 700 (like the first section 502 of the lyophilization container 500 illustrated in FIGS. 4-10). The second portion 720 may be configured to receive a second section or portion of the lyophilization container to be supported by the lyophilization fixture 700 (like the second section 508 of the lyophilization container 500 illustrated in FIGS. 4-10).

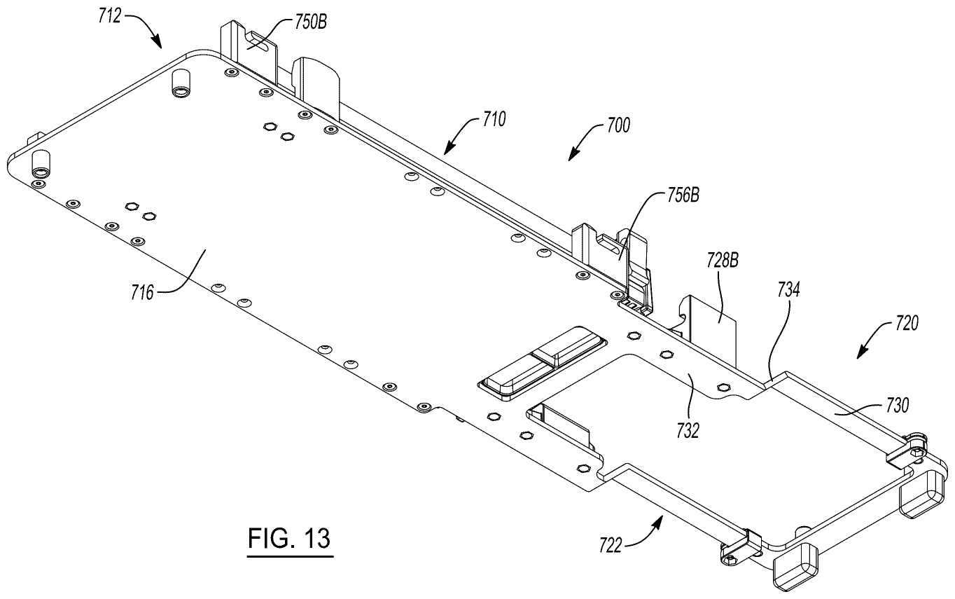

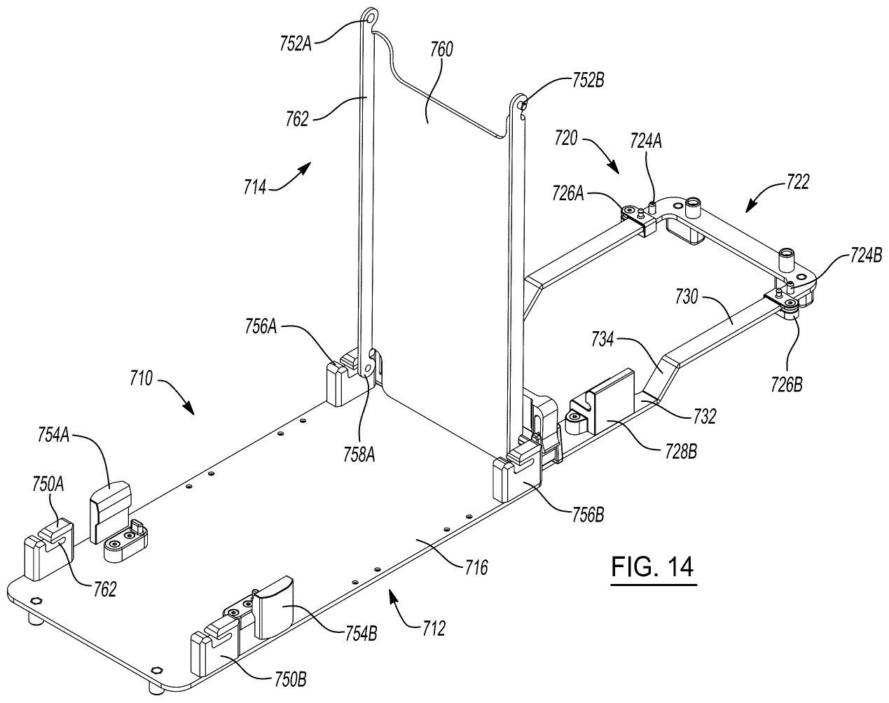

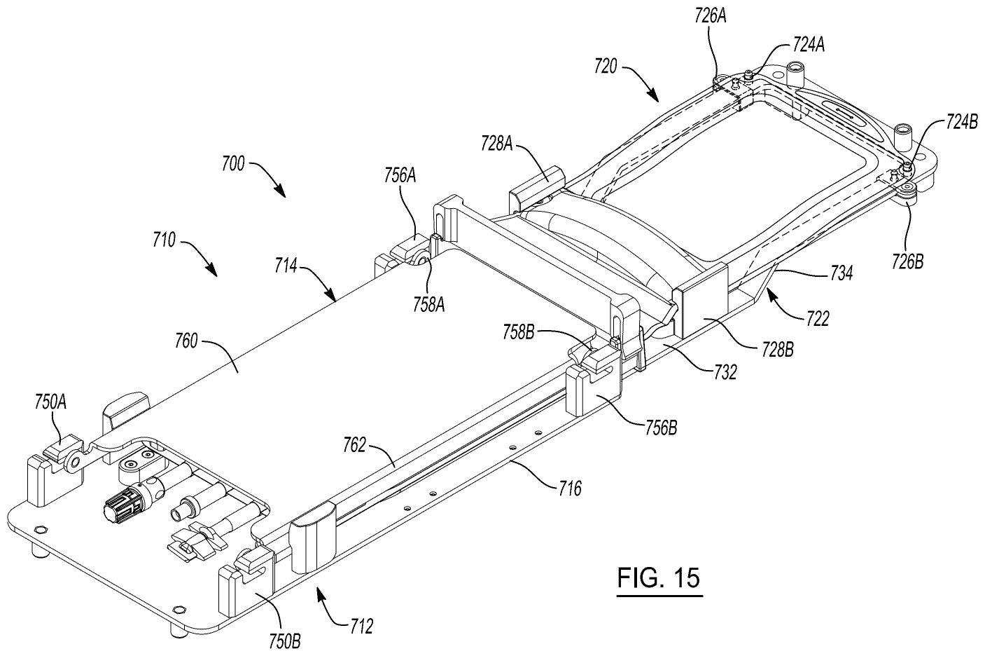

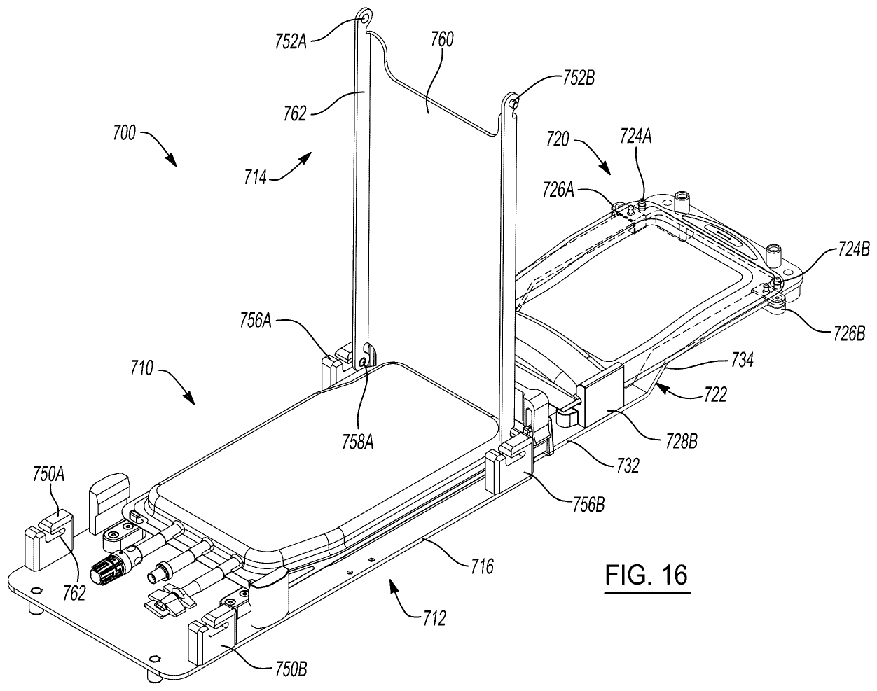

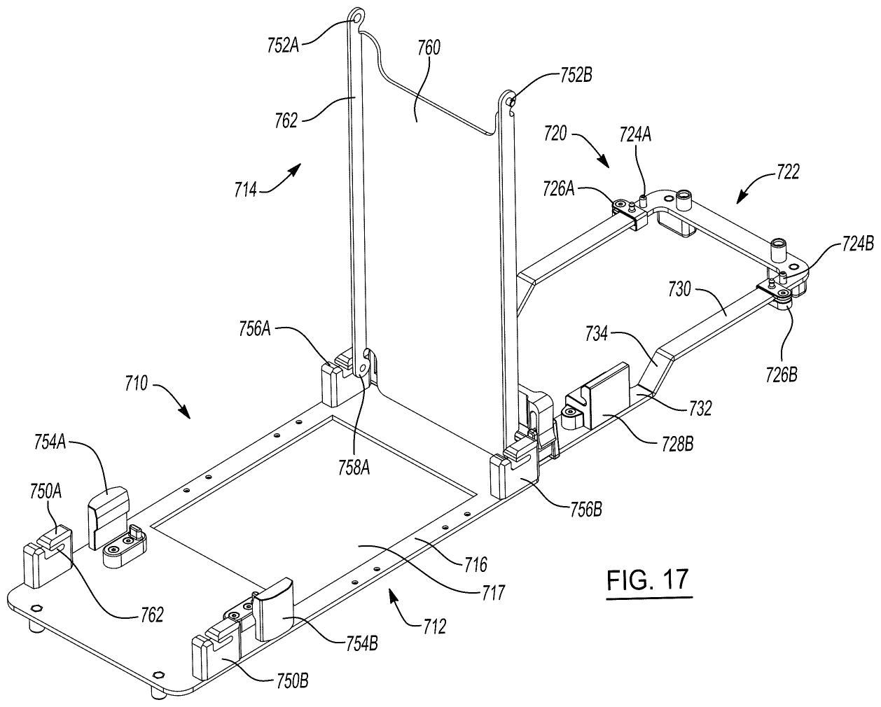

In at least one example embodiment, the first portion 710 of the lyophilization fixture 700 includes a chassis (or base or base member) 712 and a lid (or lid member) 714 movable between a first (or opened) position as illustrated in FIGS. 14 and 16 and a second (or closed) position as illustrated in FIGS. 12 and 15. The chassis 712 includes a surface 716 configured to receive the first section of the lyophilization container (like the first section 502 of the lyophilization container 500 illustrated in FIGS. 4-10). As illustrated, the surface 716 may be a substantially planar surface to aid in the production of thin and substantially uniform ice structures. In at least one example embodiment, as best illustrated, for example, in FIG. 13, the surface 716 may be substantially continuous surface (i.e., a solid surface). In other example embodiment, as best illustrated, for example, in FIG. 17, the surface 716 may have a frame-like structure that includes (or defines) an opening (or cavity) 717.

The chassis 712 also includes one or more coupling members for engaging the lid 714 to define a cavity (or housing) 718 that holds and secures the first section of the lyophilization container (like the first section 502 of the lyophilization container 500 illustrated in FIGS. 4-10). For example, in at least one example embodiment, as illustrated, the chassis 712 may include a first set (or pair) of couplers (or coupling bodies or coupling members) 750A, 750B configured to engage or secure a first portion (or section) of the first section of the lyophilization container away from the second section of the lyophilization container. As best illustrated, for example, in FIGS. 12 and 15, the first couplers 750A, 750B may be configured to receive respective coupling members (or coupling projections or coupling members) 752A, 752B extending from the lid 714.

In at least one example embodiment, the one or more coupling members may include a second set (or pair) of couplers 754A, 754B also configured to engage or secure the first portion of the lyophilization container away from the second section of the lyophilization container. As best illustrated, for example, in FIGS. 12 and 15, the second couplers 754A, 754B may be configured to grip the first portion of the first section of the lyophilization container away from the second section of the lyophilization container.

In at least one example embodiment, the one or more coupling members may include a third set (or pair) of couplers (or coupling bodies or coupling members) 756A, 756B configured to engage or secure a second portion (or section) of the first portion of the lyophilization container nearer to the second portion of the lyophilization container. As best illustrated, for example, in FIGS. 12 and 15, the third couplers 756A, 756B may be configured to receive respective coupling members (or coupling projections or coupling members) 758A, 758B extending from the lid 714.

In at least one example embodiment, the lid 714 may include a surface 760 that corresponds with the surface 716 of the chassis 712. The surface 760 of the lid 714 may be similarly substantially planar to aid in the production of thin and substantially uniform ice structures, for example, as detailed below in the instance of FIG. 17. The surface 760 of the lid 714 may include one or more sidewalls 762 extending therefrom to form an open box configuration. The coupling members 752A, 752B, 758A, 758B extending from the lid 714 may be the same or different and, in at least one example embodiment, may each extend from the one or more sidewalls 762 of the lid 714. As illustrated best in FIGS. 14 and 16, the one or more lid coupling members 752A, 752B, 758A, 758B and the respective first and third coupling members 750A, 750B, 756A, 756B of the chassis 712 may functions as hinges so to allow the lid 714 to be moved between the opened position as illustrated in FIGS. 14 and 16 and the closed position as illustrated in FIGS. 12 and 15. For example, respective first and third coupling members 750A, 750B, 756A, 756B of the chassis 712 may have slots 762 configured for the receipt of and sliding of the respective lid coupling member 752A, 752B, 758A, 758B. In at least one example embodiment, the first members 750A, 750B of the chassis 712 together with lid coupling member 752A, 752B may define a (first) hinge that allows for movement of the lid 714. In at least one example embodiment, third coupling members 756A, 756B may define a (second) hinge that allows for movement of the lid 714. In this manner, the lid 714 may be movable from either direction using the respectively defined hinges.

In at least one example embodiment, the second portion 720 of the lyophilization fixture 700 includes a frame (or supporting member or frame member) 722 for receiving (or supporting or holding) the second section of the lyophilization container (like the second section 508 of the lyophilization container 500 illustrated in FIGS. 4-10). The frame 722 may include a first portion (or section) defining a first major plane 730 of the frame 722 and a second portion (or section) defining a second major plane 732 of the frame 722. The second major plane 732 of the frame 722 may be separated from and may be disposed lower than (or below) the first major plane 730. In at least one example embodiment, as illustrated, the second major plane 732 may be line with (or extend continuously from or formed integrally with) the chassis 712 of the first portion 710 of the lyophilization fixture 700, and more specifically, the surface 716 of the chassis 712. A third (or angled) portion (or section) 734 may join together the first and second major planes 730, 732. In this manner, the frame 722 has a shape configured to receive, for example, the different sections of the a lyophilization container (including, for example, sections 502, 508, 514 of the lyophilization container 500 illustrated in FIGS. 4-10).

The frame 722 also includes one or more coupling means for joining the frame 722 to the second section of the lyophilization container (like the second section 508 of the lyophilization container 500 illustrated in FIGS. 4-10). For example, as illustrated, the one or more coupling means may include a first set (or pair) of couplers 724A, 724B configured to engage with and secure a first portion (or section) of the second section of the lyophilization container away from the first section of the lyophilization container. As best illustrated, for example, in FIGS. 15 and 16, the first couplers 724A, 724B may be configured to extend through one or more apertures of the lyophilization container to be supported by the lyophilization fixture 700 (like the apertures 548 of the lyophilization container 500 illustrated in FIGS. 4-10).

In at least one example embodiment, as illustrated, the one or more coupling means may include a second set (or pair) of couplers 726A, 726B configured to also engage with and secure the first portion of the second section of the lyophilization container away from the first section of the lyophilization container. As best illustrated, for example, in FIGS. 15 and 16, the second couplers 726A, 726B may be configured to extend over a portion of the lyophilization container.

In at least one example embodiment, as illustrated, the one or more coupling means may include a third set (or pair) of couplers 728A, 728B configured to engage with and secure a second portion of the second section of the lyophilization container nearer to the first section of the lyophilization container. As best illustrated, for example, in FIGS. 15 and 16, the third couplers 728A, 728B may be configured to grip the portion of the second section of the lyophilization container nearer to the first section of the lyophilization container.

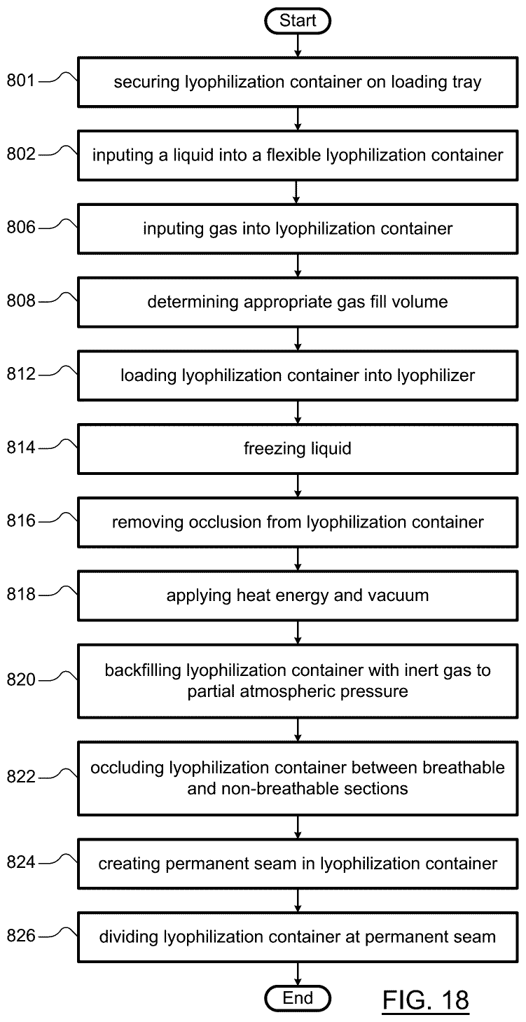

In various aspects, the present disclosure provides methods (or processes) for lyophilization. For example, FIG. 18 illustrates an example lyophilization process 800, for example, using the example lyophilizers illustrated in FIGS. 1 and 2 and/or the example shelfing structure illustrated in FIG. 3 and/or the example lyophilization container 500 illustrated in FIGS. 4-10 and/or the example lyophilization fixture 700 illustrated in FIGS. 12-16.

The method 800 may include securing a lyophilization container (like the lyophilization container 500 illustrated in FIGS. 4-10) on a loading tray of a lyophilizer (like the lyophilizers illustrated in FIGS. 1 and 2). The method 800 may include, additionally or alternatively, introducing (or inputting) 802 a fluid (e.g., blood plasma) into the lyophilization container, and more particularly, into a non-breathable section of the lyophilization container (such as, the first section 502 of the lyophilization container 500 illustrated in FIGS. 4-10). The method 800 may include, additionally or alternatively, introducing 806 gas (e.g., nitrogen) into the non-breathable section of the lyophilization container. The method 800 may include, additionally or alternatively, determining 808 an appropriate gas fill volume, prior to or during the introduction 806.

The method 800 may include, additionally or alternatively, loading 812 the lyophilization container into a lyophilizer. The method 800 may include, additionally or alternatively, freezing 814 the fluid to create a thin, frozen structure having a substantially uniformed thickness. The method 800 may include, additionally or alternatively, removing 816 an occlusion between the non-breathable section of the lyophilization container and a breathable section of the lyophilization container (such as, the second section 508 of the lyophilization container 500 illustrated in FIGS. 4-10). The removal of the occlusion may include, for example, opening a peelable seal and/or the release of one or more mechanical clamps. The method 800 may include, additionally or alternatively, causing 818 sublimation and desorption, for example, by applying vacuum and/or heat energy to cause a phase change of the frozen structure from the solid phase directly to the vapor phase. Vapor released from the frozen structure will flow through the unoccluded lyophilization container and escape through the breathable section of the lyophilization container to create (or leave behind) a lyophilized plasma cake in the non-breathable section of the lyophilization container. The method 800 may include, additionally or alternatively, introducing 820 a gas (e.g., carbon dioxide) into the lyophilization container to raise the lyophilization container pressure to partial atmospheric pressure. Introducing 820 the gas may help to provide a space to facilitate vapor flow (such as during a lyophilization phase) and/or help to create a pressure gradient to open the peel seal when the chamber pressure is reduced after freezing.

The method 800 may include, additionally or alternatively, occluding 822 the lyophilization container (for example, the third section 514 of the lyophilization container 500 illustrated in FIGS. 4-10). The method 800 may include, additionally or alternatively, permanently sealing 824 the non-breathable section of the lyophilization container. The method 800 may include, additionally or alternatively, separating 826 (for example, dividing) the non-breathable section of the lyophilization container and the breathable section of the lyophilization container, for example, at the permanent seam.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lyophilization container comprising:
a first section including
a first layer,
a second layer aligned with the first layer, and
a cavity defined by the alignment of the first and second layers, at least one of the first and second layers being preformed to have a three-dimensional shape.

2. The lyophilization container of claim 1, wherein the three-dimensional shape includes a planar surface and sides angled away from the planar surface.

3. The lyophilization container of claim 2, wherein the sides are substantially perpendicular to the planar surface.

4. The lyophilization container of claim 2, wherein the three-dimensional shape has an open-box configuration.

5. The lyophilization container of claim 2, wherein
the planar surface is a first planar surface,
the first layer includes the three-dimensional shape, and
the second layer includes a second planar surface that is coupled to the sides of the three-dimensional shape to define the cavity.

6. The lyophilization container of claim 1, wherein
the three-dimensional shape is a first three-dimensional shape,
the first layer includes the first three-dimensional shape, and
the second layer includes a second three-dimensional shape.

7. The lyophilization container of claim 6, wherein the first and second three-dimensional shapes are the same.

8. The lyophilization container of claim 6, wherein
the first three-dimensional shape includes a first planar surface and first sides angled away from the first planar surface,
the second three-dimensional shape includes a second planar surface and second sides angled away from the second planar surface, the first and second planar being substantially parallel and the first and second sides coupled together to define the cavity.

9. The lyophilization container of claim 1, wherein the first and second layers are different parts of a continuous sheet.

10. The lyophilization container of claim 1, wherein
the cavity is a first cavity, and
the lyophilization container further includes:
a second section including
a third layer,
a fourth layer aligned with the third layer, and
a second cavity defined by the alignment of the third and fourth layers, at least one of the third and fourth layers including a breathable membrane.

11. The lyophilization container of claim 10, wherein the third and fourth layers are different parts of a continuous sheet.

12. The lyophilization container of claim 10, wherein one of the first and second sections of the lyophilization container includes one or more apertures for securing the lyophilization container to a lyophilization fixture.

13. The lyophilization container of claim 12, wherein the lyophilization fixture includes
a first portion configured to support the first portion of the lyophilization container, the first portion including a base and a movable lid that together define a housing that receives the first portion of the lyophilization container; and
a second portion configured to support the second portion of the lyophilization container.

14. The lyophilization container of claim 10, wherein the lyophilization container further includes:
an occluding section disposed between the first section and the second section,
the occluding section movable between a first configuration and a second configuration,
the occluding section in the first configuration preventing liquid movement between the first and second cavities, and
the occluding section in the second configuration allowing for liquid movement between the first and second cavities.

15. A method for forming a lyophilization container, the method comprising:
heating a sheet to a pliable temperature;
disposing the sheet on or near a surface of a mold structure including a portion shaped to mold the sheet to form a layer having an open box configuration, the open box configuration including a planar surface and sides angled away from the planar surface; and
cooling the layer to form the lyophilization container.

16. The method of claim 15, wherein
the layer is a first layer,
the portion is a first portion,
the mold structure further including a second portion shaped to mold the sheet to form a second layer continuous with the first layer, and
the method further including:
aligning the second layer with the first layer to define a cavity.

17. The method of claim 16, wherein
the open box configuration is a first open box configuration,
the planar surface is first planar surface,
the sides are first sides,
the second layer has a second open box configuration,
the second open box configuration including a second planar surface and second sides angled away from the second planar surface, and
the method further includes:
joining together the first and second sides together to enclose the cavity.

18. The method of claim 15, wherein the method includes using a vacuum to mold the sheet to form the layer having the open box configuration.

19. The method of claim 15, wherein
the sheet is a first sheet, the pliable temperature is a first pliable temperature,
the mold is a first mold,
the layer is a first layer,
the open box configuration is a first open box configuration,
the planar surface is a first planar surface,
the sides are first sides, and
the method further includes:
heating a second sheet to a second pliable temperature;
disposing the second sheet on or near a surface of a second mold structure including a portion shaped to mold the sheet to form a second layer having a second open box configuration,
the second open box configuration including a second planar surface and second sides angled away from the second planar surface; and
joining together the first and second sides together to enclose the cavity.

20. A method of using a lyophilization container, the method comprising:
obtaining a lyophilization container, the lyophilization container including
a first section including
a first layer,
a second layer aligned with the first layer, and
a cavity defined by the alignment of the first and second layers, at least one of the first and second layers preformed to have a three-dimensional shape; and
a second section including
a third layer,
a fourth layer aligned with the third layer, and
a second cavity defined by the alignment of the third and fourth layers, at least one of the third and fourth layers including a breathable membrane; and
disposing the lyophilization container in a lyophilization fixture, the lyophilization fixture including
a first portion configured to support the first portion of the lyophilization container, the first portion including a base and a movable lid that together define a housing that receives the first portion of the lyophilization container; and
a second portion configured to support the second portion of the lyophilization container.
